(19) United States
(12) Patent Application Publication
(10) Pub. No.: US 2024/0156075 A1
(43) Pub. Date: May 16, 2024

(54) Rod Guide

(71) Applicant: Mark Adam Tully, Dufresne (CA)

(72) Inventor: Mark Adam Tully, Dufresne (CA)

(21) Appl. No.: 18/449,823

(22) Filed: Aug. 15, 2023

Related U.S. Application Data
(60) Provisional application No. 63/371,627, filed on Aug. 16, 2022.

(51) Int. Cl. A01K 87/04

(52) U.S. Cl. CPC A01K 87/04

(57) ABSTRACT

The invention provides an improved fishing guide, specifically the tip top guide style. The guide consists of a single continuous piece of wire, bent in a manner to create a guide foot, guide ring, an elbow where the wires remain parallel after bending away from the vertical guide foot either inwards towards the guide ring, or outwards away from the guide ring, and a barrier on the rear portion of the guide above the guide foot that prevents the line from sliding between the two wires emerging from the guide foot. This protects the line from pinch points that are common in tip top style guides made of a single wire.

### FIELD OF DISCLOSURE

The present invention relates to the end fishing line guide known as a tip top guide on a fishing rod. This is intended for guides made from a single continuous length of wire that benefit from weight reduction, ice shedding and the ability to use super elastic alloys.

### INTRODUCTION

Historically, wire style guides have disadvantages on the tip top application. The wire creates a pinch point where it meets at the base of the guide where the guide foot begins. This pinch point is most commonly experienced when the lure is hooked to the hook keeper at the base of the rod. The line slides to the back portion of the tip top guide and is pinched and potentially weakened. Secondly, a disadvantage of current wire tip tops is that the rod blank can be exposed past the tip top guide creating a protrusion that the fishing line can get caught around.
Reference: U.S. Pat. No. 6,612,065

### SUMMARY

Embodiments of the present invention are devised to solve the previously mentioned problems of wire style tip top fishing line guides. Considered broadly, fishing line guides are round hoops affixed to a fishing rod, through which the fishing line is threaded. The tip top fishing line guide is the last fishing guide on the end of the rod. In an embodiment, the present invention is a single continuous length of wire comprising a guide foot, guide ring, an elbow where the wires remain parallel after bending away from the vertical guide foot either inwards towards the guide ring, or outwards away from the guide ring, and a barrier on the rear portion of the guide above the guide foot that prevents the line from sliding between the two wires emerging from the guide foot. Some embodiments of the present invention prevent the line falling into the base of the guide where the previously described pinch point is present. This is achieved by bends in the wire that creates a safe smooth corner on either side of the rear portion of the guide to catch the line. The wire is bent such that it creates a barrier, preventing the natural sliding of the line into the pinch point. Other embodiments of this invention provide a protrusion opposite the guide ring on the back side of the guide foot that acts as a stop to align the rod blank against while manufacturing. During manufacturing this protrusion is pushed into contact with the end of the rod blank, providing the correct location for the guide to be tied at. This prevents the previously mentioned problem of the rod blank extending past the tip top far enough to create a protrusion that can catch or damage the fishing line.

In an embodiment, this new invention consists of a guide foot or base that is affixed to the rod, an elbow where the guide wire orientation bends from the guide foot. The elbow starts in a vertical orientation parallel with the rod blank to a nearly horizontal orientation perpendicular to the rod blank. The embodiment further consists of a front portion that is furthest from the rod blank and a rear portion adjacent to guide foot. The rear portion is unique in its line management in that when the line extending from the tip top is routed back parallel to the rod blank (as it is when attaching a hook to the hook keeper), the rear portion of the guide catches the line in a smooth corner that does not allow it to slide into the previously described pinch point. The elbow is unique in that the wires remain parallel after leaving the rod blank, bending either inward towards the front portion of the guide, or outward opposite the front portion of the guide.

The present invention is to be comprised of, but is not limited to the following materials: nickel titanium alloy materials, other super elastic shape memory alloys, steel, nickel or brass.

### BRIEF DESCRIPTION OF THE DRAWINGS

In the drawings, which form a part of this specification,

FIG. 1 is a plan view of the present invention

FIG. 2 is a side view of the present invention including the typical rod blank location.

FIG. 3 is an isometric view of the present invention.

FIG. 4 is an isometric view of another possible design or embodiment of the invention

### DETAILED DESCRIPTION

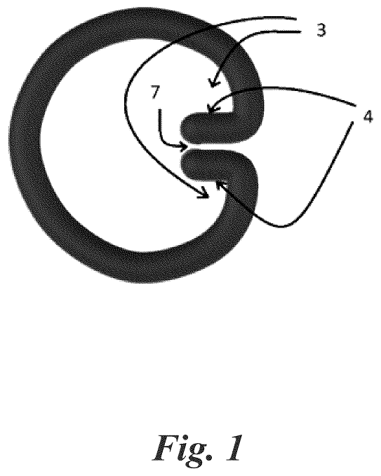

FIG. 1 Illustrates the line guide from a top view with an exemplary embodiment of the present invention. The guide is separated into two portions. The front portion and the rear portion. The rear portion is formed such that there are two spaces 3 next to a barrier 4. The gap space 3 catches the line such that it doesn't slide into the gap 7. The barrier 4 is a short bend that prevents the line from naturally sliding into the gap 7.

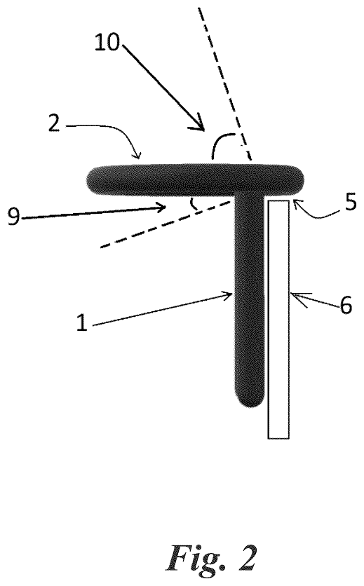

FIG. 2 Illustrates the line guide from a side view showing the guide ring 2 that the line is threaded through to manage the fishing line during typical retrieve, casting or jigging. This guide hoop can be angled down as much as 15 degrees 9 or up as far as 80 degrees 10. The guide foot 1 is tied to the rod blank 6 during manufacturing. The alignment of the rod blank is determined by protrusion 5 which acts as a stop during manufacturing, allowing the rod blank to be butted against protrusion 5 for the proper alignment of the tip top guide during manufacturing.

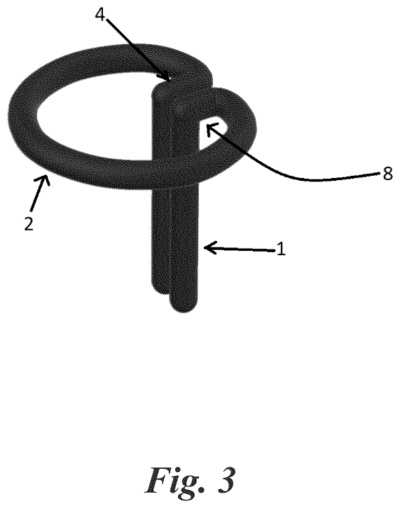

FIG. 3 illustrates the line guide showing the elbow 8 is a unique bend that creates the barrier that prevents the line from entering in the pinch point. The wire is parallel on the guide foot 1 and remains parallel after bending at the elbow 8. The parallel wires continue rearward, opposite the guide ring 2 to form the barrier 4.

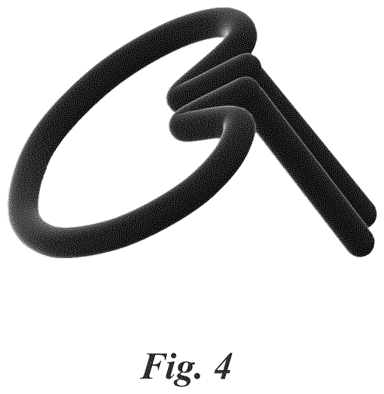

FIG. 4 illustrates another embodiment where the wire bends forwards from the foot to form the barrier.

1. A line guide fixable to the top of a fishing rod formed from a single continuous length of wire comprising a guide foot, guide ring, an elbow where the wires remain parallel after bending away from the vertical guide foot either inwards towards the guide ring, or outwards away from the guide ring, and a barrier on the rear portion of the guide above the guide foot that prevents the line from sliding between the two wires emerging from the guide foot.

2. A tip top line guide made from a single continuous length of wire with a rearward protrusion opposite the ring of the guide where the rearward protrusion helps to align the rod blank against the guide during manufacturing.

3. A line guide comprised of a guide foot, elbow and guide ring with a separate part affixed to the guide or rod tip to act as a barrier at the elbow of the guide.

4. The guide of claim 1 where the bend can be comprised of an outward bend to act as a gap that catches the line, an inward bend that acts as a barrier to prevent the line from entering the space where the wire of the guide foot emerges from the rod, or a combination of outward and inward bends.

5. The tip top line guide of claim 1, made from nickel titanium alloy material that has been heat treated and cold worked to achieve pseudo-elasticity within a temperature range from −30 degrees Celsius to 50 degrees Celsius.

6. The guide of claim 1 where the guide ring is angled up from the horizontal plane between 0 degrees and 80 degrees.

7. The guide of claim 1 where the guide ring is angled down from the horizontal plane between 0 degrees to 15 degrees.
